(19) United States
(12) Patent Application Publication
(10) Pub. No.: US 2022/0251895 A1
(43) Pub. Date: Aug. 11, 2022

(54) POWER WINDOW DEVICE

(71) Applicants: So FUJIOKA, Aichi (JP); Katsunori KIGOSHI, Aichi (JP); Atsushi FUJITA, Aichi (JP); Tatsuki NAGATA, Aichi (JP); Yuki YAMAMOTO, Aichi (JP); Masahiko HARA, Aichi (JP)

(72) Inventors: So FUJIOKA, Aichi (JP); Katsunori KIGOSHI, Aichi (JP); Atsushi FUJITA, Aichi (JP); Tatsuki NAGATA, Aichi (JP); Yuki YAMAMOTO, Aichi (JP); Masahiko HARA, Aichi (JP)

(73) Assignee: NIDEC MOBILITY CORPORATION, Aichi (JP)

(21) Appl. No.: 17/592,511

(22) Filed: Feb. 4, 2022

(30) Foreign Application Priority Data
Feb. 8, 2021 (JP) 2021-018110

(51) Int. Cl. E05F 15/695; B60J 1/17

(52) U.S. Cl. CPC E05F 15/695; B60J 1/17

(57) ABSTRACT

A power window device includes a control unit configured to: monitor independently a first potential at one ends of a first switch circuit including a window closing switch and a second switch circuit including a window opening switch and a second potential at one end of a submersion detection sensor, and determine that submersion has occurred when the second potential is in a submersion potential range. During a normal time, the control unit outputs a window closing command signal when the first potential is a potential at a time of the window closing switch being operated, and outputs a window opening command signal when the first potential is a potential at a time of the window opening switch being operated. At a time of submersion, the control unit does not output the window closing command signal, and outputs the window opening command signal.

### CROSS-REFERENCE TO RELATED APPLICATIONS

This application is based upon and claims the benefit of priority from Japanese Patent Application No. 2021-018110 filed on Feb. 8, 2021, the entire contents of which are incorporated herein by reference.

### FIELD

One or more embodiments of the present invention relate to a power window device that opens and closes a window by a motor, and more particularly to a technology for preventing the window from closing due to an error in switch operation when a vehicle is submerged.

### BACKGROUND

A power window device mounted on a vehicle is a device that rotates a motor forward or reversely according to an operation state of a switch including an operation unit, and opens and closes a window via an opening/closing mechanism provided between the motor and the window When the switch is operated to an UP (window closing) side, the motor rotates forward to close the window, and when the switch is operated to a DOWN (window opening) side, the motor rotates reversely to open the window. The forward and reverse rotation of the motor is controlled by switching a direction of a current flowing through the motor.

Even in a case where the vehicle is submerged and the window opening/closing control cannot be performed normally, such a power window device has a function that can detect submersion, and forcibly open the window by an operation of a switch to enable escape from the window and ensure the safety of an occupant, In JP-A-2018100507, JP-B2-6634351, JP-A-2018-135726, JP-A-2019-015115, and JP-A-2020-087834, a power window device with such a submersion detection function is described.

The power window device described in JP-A-2018-100507, JP-B2-6634351, JP-A-2018-135726, and JP-A-2019-015115 has a submersion detection sensor formed of a pair of electrodes disposed at intervals. The power window device described in JP-A-2020-087834 detects submersion based on a comparison result between a voltage of the terminal and a threshold value when a constant current is passed through an input terminal of the control unit, instead of providing the submersion detection sensor.

In the power window device of JP-A-2018-100507, JP-B2-6634351, JP-A-2018-135726, and JP-A-2019-015115, a switching element that turns on and off depending on presence or absence of detection by a submersion detection sensor is provided, Then, at the time of submersion, the submersion is detected by changing a voltage of the input terminal of the control unit by turning on the switching element. Therefore, as means for detecting submersion, a switching element such as a transistor or a relay is required in addition to the submersion detection sensor, a circuit configuration becomes complicated, and in a case where the switching element fails, submersion detection cannot be performed. On the other hand, the power window device of JP-A-2020-087834 also requires a constant current circuit to detect submersion, so that the circuit configuration is inevitably complicated, and if the switching element provided in the constant current circuit fails, submersion detection cannot be performed.

In addition, in the power window device, when the window is closed by an erroneous switch operation when the vehicle is submerged, the window is closed and the occupant is difficult to escape, thereby threatening the safety of the occupant. Therefore, measures for that are also required. For example, in JP-A-2018-100507, there is provided a first switching element that turns on when the detection pad is short-circuited when the vehicle is submerged, and a second switching element that turns on when the first switching element turns on, When submersion is detected and each switching element turns on, one end of the window closing switch on a power supply side is grounded by the second switching element. Therefore, even if the window closing switch is operated, no current flows through the switch and the switch operation is not detected, so that it is possible to prevent the window from being erroneously closed when the vehicle is submerged. However, in order to realize this function, the switching element described above is required, so that the circuit configuration becomes more complicated.

### SUMMARY

One or more embodiments of the invention are provided to realize a power window device having high safety and reliability while having a simple circuit configuration.

The power window device according to one or more embodiments of the present invention includes an operation unit including a window closing switch that is operated to close a window and a window opening switch that is operated to open the window; a motor drive unit that drives a motor to open and close the window; a control unit that controls an operation of the motor drive unit based on an operation of each switch of the operation unit; and a submersion detection circuit that detects submersion. The operation unit includes a first switch circuit connected between a first power supply and a ground, the first switch circuit including a series circuit of the window closing switch and a resistor, and a second switch circuit connected between the first power supply and the ground in parallel with the first switch circuit, the second switch circuit including the window opening switch. The submersion detection circuit has a submersion detection sensor connected between a second power supply and the ground. The control unit monitors independently a first potential at one ends of the first switch circuit and the second switch circuit on a first power supply side and a second potential at one end of the submersion detection sensor on a second power supply side. Then, the control unit determines that submersion has occurred when the second potential is in a preset submersion potential range. During a normal time when there is no submersion, the control unit outputs a window closing command signal for giving an instruction to close the window to the motor drive unit when the first potential is a potential at a time of the window closing switch being operated, and outputs a window opening command signal for giving an instruction to open the window to the motor drive unit when the first potential is a potential at a time of the window opening switch being operated. On the other hand, at a time of submersion in which submersion occurs, the control unit does not output the window closing command signal to the motor drive unit even when the first potential is the potential at the time of the window closing switch being operated, and outputs the window opening command signal to the motor drive unit when the first potential is the potential at the time of the window opening switch being operated.

According to the configuration. the first potential at one end of the first and second switch circuits, and the second potential at one end of the submersion detection sensor are monitored individually by the control unit. Then, when the window opening switch is operated at the time of submersion when the second potential is in the range indicating submersion, if the window opening switch is operated, the window can be opened based on the window opening command signal output from the control unit due to the change in the first potential. On the other hand, even if the window closing switch is erroneously operated at the time of submersion, the window closing command signal is not output from the control unit, so that it is possible to avoid a situation where the window is closed and safety is threatened. Therefore, even if a switching element that turns on and off depending on presence or absence of detection by a submersion detection sensor as in JP-A-2018-100507, JP-B2-6634351, JP-A-2018-135726, and J P-A-2019-015115, a constant current circuit as in JP-A-2020-087834, and the like are not provided, it is possible to open the window and realize a highly safe power window device that can prevent the window from being erroneously closed at the time of submersion by a simple circuit configuration. In addition, it is possible to avoid a situation in which submersion detection cannot be performed due to a failure of the switching element, and reliability is improved.

In one or more embodiments of the present invention, with respect to the first potential, a window closing threshold value for determining presence or absence of an operation of the window closing switch and a window opening threshold value for determining presence or absence of an operation of the window opening switch may be set in the control unit, and with respect to the second potential, a submersion threshold value for determining presence or absence of submersion may be set in the control unit. In this case, the submersion potential range may be a range between the submersion threshold value and zero volt, and the window closing threshold value and the window opening threshold value may be smaller than the submersion threshold value.

In one or more embodiments of the present invention, when it is determined that submersion has occurred based on the submersion threshold value, the control unit may not determine presence or absence of the operation of the window closing switch based on the window closing threshold value, and may only determine presence or absence of the operation of the window opening switch based on the window opening threshold value.

In one or more embodiments of the present invention, the window opening threshold value may be smaller than the window closing threshold value.

In one or more embodiments of the present invention, the window closing switch may include a manual closing switch for manually closing the window and an auto-closing switch for automatically closing the window, the window opening switch may include a manual opening switch for manually opening the window and an auto-opening switch for automatically opening the window, and the resistor may include a first voltage dividing resistor, a second voltage dividing resistor, and a third voltage dividing resistor. In this case, the first switch circuit may include the auto-opening switch, the auto-closing switch, the manual closing switch, the first voltage dividing resistor, the second voltage dividing resistor, and the third voltage dividing resistor, and the second switch circuit may include the manual opening switch. In the first switch circuit, a series circuit of the manual closing switch, the first voltage dividing resistor, the second voltage dividing resistor, and the third voltage dividing resistor, a series circuit of the auto-closing switch, the first voltage dividing resistor, and the second voltage dividing resistor, and a series circuit of the auto-opening switch and the first voltage dividing resistor may be connected between the first power supply and the ground. In the second switch circuit, the manual opening switch may be connected between the first power supply and the ground.

In one or more embodiments of the present invention, the operation unit may have a first terminal to which each of the one ends of the first switch circuit and the second switch circuit is connected and a second terminal to which the one end of the submersion detection sensor is connected. Further, the control unit may have a third terminal connected to the first terminal by a first wiring and a fourth terminal connected to the second terminal by a second wiring. Further, the third terminal may be connected to the first power supply via a first pull-up resistor, and the fourth terminal may be connected to the second power supply via a second pull-up resistor. The control unit may monitor a potential at the third terminal as the first potential and monitor a potential at the fourth terminal as the second potential.

According to one or more embodiments of the present invention, it is possible to realize a power window device having high safety and reliability while having a simple circuit configuration.

### BRIEF DESCRIPTION OF DRAWINGS

FIG. 1 is a circuit diagram illustrating a first embodiment of the present invention;

FIG. 2 is a diagram for explaining a determination threshold value used in a normal time;

FIG. 3 is a diagram for explaining a determination threshold value used at a time of submersion;

FIG. 4 is a diagram illustrating a first potential and a second potential at a normal time;

FIG. 5 is a diagram illustrating a first potential and a second potential at the time of submersion:

FIG. 6 is a circuit diagram illustrating a second embodiment of the present invention; and

FIG. 7 is a circuit diagram illustrating a third embodiment of the present invention.

### DETAILED DESCRIPTION

In embodiments of the invention, numerous specific details are set forth in order to provide a thorough understanding of the invention. However, it will be apparent to one of ordinary skill in the art that the invention may be practiced without these specific details. In other instances, well-known features have not been described in detail to avoid obscuring the invention.

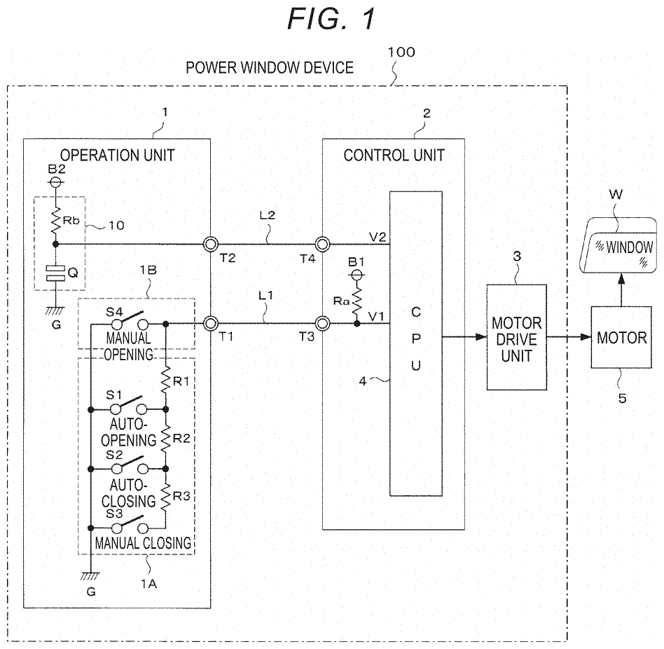

Embodiments of the present invention will be described with reference to the drawings. FIG. 1 illustrates a power window device according to a first embodiment. A power window device 100 includes an operation unit 1, a control unit 2, and a motor drive unit 3, The operation unit 1 and the control unit 2 are unitized, respectively, and both are electrically connected by wirings L1 and L2 such as cables.

The operation unit 1 is provided with a switch circuit 1A (first switch circuit), a switch circuit 1B (second switch circuit), a submersion detection circuit 10, a terminal T1 (first terminal), and a terminal T2 (second terminal). The control unit 2 is provided with a CPU 4, a pull-up resistor Ra (first pull-up resistor), a terminal T3 (third terminal), and a terminal T4 (fourth terminal).

In the control unit 2, one end of the pull-up resistor Ra is connected to a power supply B1 (first power supply), and the other end of the pull-up resistor Ra is connected to the terminal T3. The terminal T3 is connected to the terminal T1 of the operation unit 1 by the wiring L1 (first wiring). Further, the terminal T4 is connected to the terminal T2 of the operation unit 1 by the wiring L2 (second wiring).

In the operation unit 1, one ends of the switch circuits 1A and 1B are connected to the terminal TI, and the other ends of the switch circuits 1A and 1B are connected to the ground G, respectively. That is, the switch circuit 1A and the switch circuit 1B are connected in parallel between the power supply B1 and the ground G. The submersion detection circuit 10 includes a series circuit of a pull-up resistor Rb (second pull-up resistor) and a submersion detection sensor Q, and is connected between the power supply B2 (second power supply) and the ground G. One end of the submersion detection sensor Q on a power supply B2 side is connected to the terminal T2. The submersion detection sensor Q is configured of, for example, a pair of electrodes (pads) disposed at intervals on a substrate.

Although the power supply B1 and the power supply B2 are distinguished in FIG. 1, they may be the same power supply. Further, the resistance values of the pull-up resistor Ra and the pull-up resistor Rb may be the same or different. Hereinafter, a voltage of the power supply B1 is referred to as B1, and a voltage of the power supply B2 is referred to as B2 for convenience.

In the operation unit 1, the switch circuit 1A has switches S1 to S3 and resistors R1 to R3. The switch S1 is an auto-opening switch for automatically opening the window, and the switch S2 is an auto-closing switch for automatically closing the window The switch S3 is a manual closing switch for manually closing the window. The resistors R1 to R3 are voltage dividing resistors connected in series.

The switch circuit 1B has a switch S4. The switch S4 is a manual opening switch for manually opening the window. The auto-opening switch S1 and the manual opening switch S4 are examples of the “window opening switch” in one or more embodiments of the present invention, and the auto-closing switch S2 and the manual closing switch S3 are examples of the “window closing switch” in one or more embodiments of the present invention.

In the case of the auto-opening switch S1, the window opening operation continues even if the operation is released after the operation, whereas in the case of the manual opening switch S4, the window opening operation is performed only While the operation state is held, and when the operation is released, the window opening operation is stopped. Further, in the case of the auto-closing switch S2, the window closing operation is continued even if the operation is released after the operation, whereas in the case of the manual closing switch S3, the window is closed only while the operation state is held, and when the operation is released, the window closing operation is stopped.

In the switch circuit 1A, a series circuit of the manual closing switch S3, the resistor R1 (first voltage dividing resistor), the resistor R2 (second voltage dividing resistor), and the resistor R3 (third voltage dividing resistor) is connected between the terminal Ti and the ground G. Further, a series circuit of the auto-closing switch S2, the resistor R1, and the resistor R2 is connected between the terminal T1 and the ground G. Further, a series circuit of the auto-opening switch S1 and the resistor R1 is connected between the terminal T1 and the ground G.

In the switch circuit 1B, the manual opening switch S4 is connected between the terminal T1 and the ground G. The terminal T1 is connected to the power supply B1 via the wiring L1, the terminal T3, and the pull-up resistor Ra, and the terminal T2 is connected to the power supply B2 via the pull-up resistor Rb.

In the control unit 2, the input side of the CPU 4 is connected to the connection point between the pull-up resistor Ra and the terminal T3, and the terminal 14. The CPU 4 independently monitors the potential V1 (first potential) of the terminal T3 and the potential V2 (second potential) of the terminal T4, and controls the motor drive unit 3 based on a result thereof (details will be described later).

The motor drive unit 3 is configured of a known circuit including a PWM circuit that generates a pulse width modulation (PWM) signal, a switching circuit that performs a switching operation by the PWM signal, and the like.

In the present embodiment, the motor 5 is configured of a DC motor and rotates at a predetermined speed based on a drive voltage output from the motor drive unit 3. In the operation unit 1, when the auto-closing switch S2 or the manual closing switch S3 is operated, a window closing command signal for giving an instruction to close of the window is output from the control unit 2 (CPU4), and the motor 5 rotates forward and the window W closes based on this command signal. Further, in the operation unit 1, when the auto-opening switch S1 or the manual opening switch S4 is operated, a window opening command signal for giving an instruction to open of the window is output from the control unit 2 (CPU4), and the motor 5 rotates reversely and the window W opens based on this command signal. An opening/closing mechanism (not illustrated) is provided between the motor 5 and the window W.

Although not illustrated in FIG. 1, the control unit 2 performs feedback control for the motor drive unit 3 such that the rotation speed of the motor 5 is set as a target speed based on an output of a sensor (rotary encoder or the like) that detects the rotation speed of the motor 5.

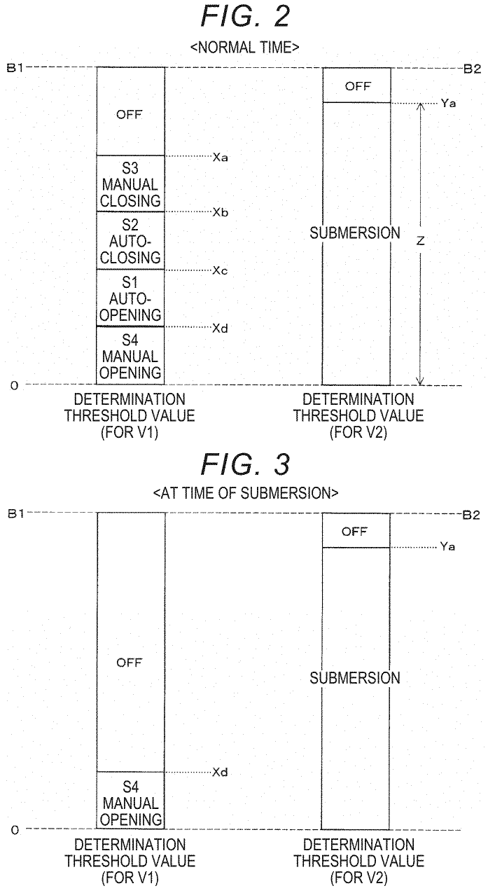

Next, submersion detection, which is a feature of one or more embodiments of the invention, will be described in detail with reference to FIGS. 2 to 5.

As described above, the CPU 4 of the control unit 2 independently monitors the potential V1 of the terminal T3 and the potential V2 of the terminal T4. Since the terminals T3 and T4 are connected to the terminals T1 and T2, respectively, the potential V1 is a potential at one ends of the switch circuits 1A and 1B on a power supply B1 side, and the potential V2 is a potential at one end of the submersion detection sensor Q on a power supply B2 side. With respect to the potential V1, a threshold value for determining the presence or absence of the operation of the switches S1 to S4 and with respect to the potential V2, a threshold value for determining the presence or absence of submersion are set in the control unit 2. Each threshold value is stored in advance in an internal memory (not illustrated) built in the CPU 4 or an external memory (not illustrated) provided separately from the CPU 4.

FIG. 2 illustrates a determination threshold value used at the normal time (when not submerged). Here, four threshold values Xa to Xd are set between the power supply voltage B1 and zero volt with respect to the potential V1, and one threshold value Ya is set between the power supply voltage B2 and zero volt with respect to the potential V2. The power supply voltages B1 and B2 have the same value.

Of the threshold values set for the potential V1, Xa is a window closing threshold value for determining that the manual closing switch S3 has been operated. Xb is a window closing threshold value for determining that the auto-closing switch S2 has been operated. Xc is a window opening threshold value for determining that the auto-opening switch S1 has been operated. Xd is a window opening threshold value for determining that the manual opening switch S4 has been operated.

The CPU 4 compares the potential Vi with each of the threshold values Xa to Xd, and if Xa≥V1>Xb, it is determined that the manual closing switch S3 is operated, determined that the auto-closing switch S2 has been operated if Xb≥V1>Xc, determined that the auto-opening switch S1 has been operated if Xc≥V1>Xd, and determined that the manual opening switch S4 has been operated if Xd≥V1>0.

On the other hand, Ya set for the potential V2 is a submersion threshold value for determining the presence or absence of submersion. The region Z (Ya≥Z≥0) between Ya and zero volt indicates the submersion potential range. The CPU 4 compares the potential V2 with the submersion threshold value Ya, and if Ya≥V2≥0 (that is, if V2 is in the submersion potential range Z), it is determined that submersion has occurred. The above-mentioned four threshold values Xa to Xd with respect to the potential V1 are smaller than the submersion threshold value Ya (Ya>Xa>Xb>Xc>Xd).

FIG. 3 illustrates a determination threshold value used at the time of submersion in which the power window device 100 is in the submerged state, At the time of submersion, only the threshold value Xd for determining the presence or absence of the operation of the manual opening switch S4 is set between the power supply voltage B1 and zero volt with respect to the potential V1. The threshold value Xd is the same as the threshold value Xd in FIG. 2. Further, for the potential V2, the same submersion threshold value Ya as in FIG. 2 is set.

In the normal state, the CPU 4 of the control unit 2 determines the presence or absence of the operation of the switches S1 to S4 as described above based on the comparison result between the potentials V1 and V2, and each threshold value in FIG. 2, and determines the presence or absence of submersion. Then, in a case where it is determined that submersion has occurred, the CPU 4 determines the presence or absence of the switch operation and the presence or absence of submersion by using the determination threshold value of FIG. 3 instead of the determination threshold value of FIG. 2.

In FIG. 3, the potential V2 is in the range of Ya≥V2≥0, while the submerged state continues. At this time, regarding the potential V1, the determination of the presence or absence of the operation of the auto-opening switch S1, the auto-closing switch S2, and the manual closing switch S3 is not performed, and only determination of the presence or absence of the operation of the manual opening switch S4 is performed based on the comparison between the potential V1 and the threshold value Xd. Then, in a case where it is determined that the manual opening switch S4 has been operated (Xd≥V1≥0), the CPU 4 outputs a window opening command signal for giving an instruction to manually open of the window W to the motor drive unit 3.

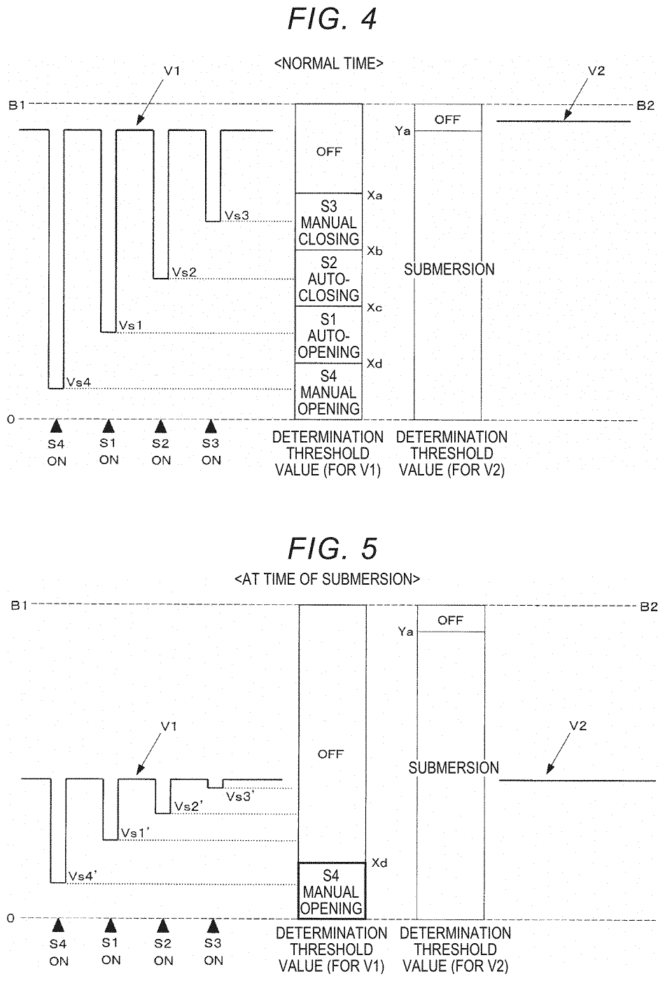

FIG. 4 illustrates a state of a change in the potentials V1 and V2 at the normal time. Since the potential V1 is the potential at the terminal T3, the potential V1 changes when the switches S1 to S4 connected to the terminal T3 are turned on. On the other hand, since the potential V2 is the potential at the terminal T4, the potential V2 does not change when the switches S1 to S4 are turned on, and the potential V2 is determined by the detection state of the submersion detection sensor Q connected to the terminal T4, in the normal state where submersion is not detected, the electrodes of the submersion detection sensor Q are not short-circuited, so that the potential V2 in FIG. 4 is in the range of B2≥V2>Ya.

In FIG. 4, when none of the switches S1 to S4 is operated, the potential V1 is B1≥V1>Xa (OFF state). Now, when the auto-opening switch S1 is operated and turned on, the potential V1 drops to Vs1. From FIG. 1, Vs1 at this time is obtained as follows:

Vs1=B1·R1/(Ra+R1)

For convenience, the resistance in the switch S1 and the wiring L1 is ignored (the same applies to Vs2, Vs3, and Vs1′ to Vs3′ described later). If Vs1 is in the range of Xc≥Vs1>Xd, the CPU 4 determines that the auto-opening switch S1 has been operated, and outputs the window opening command signal for giving instruction to automatically open of the window W to the motor drive unit 3.

Further, in FIG. 4. when the auto-closing switch S2 is operated and turned on, the potential V1 drops to Vs2. From FIG. 1, Vs2 at this time is obtained as follows:

Vs2=B1·(R1+R2)/(Ra+R1+R2)

If Vs2 is in the range of Xb≥Vs2>Xc, the CPU 4 determines that the auto-closing switch S2 has been operated, and outputs the window closing command signal instructing the automatic closing of the window W to the motor drive unit 3.

Further, in FIG. 4, when the manual closing switch S3 is operated and turned on, the potential V1 drops to Vs3. From FIG. 1, Vs3 at this time is obtained as follows:

Vs3=B1·(R1+R2+R3)/(Ra+R1+R2+R3)

If Vs3 is in the range of Xa≥Vs3>Xb, the CPU 4 determines that the manual closing switch S3 has been operated, and outputs the window closing command signal for giving an instruction to manually close of the window W to the motor drive unit 3.

Further, in FIG. 4, when the manual opening switch S4 is operated and turned on, the potential V1 drops to Vs4. Vs4 at this time is obtained as follows:

Vs4=B1·Rx/(Ra+Rx)

where the total resistance of the switch S4, the wiring L1, and the like is Rx. Here, Rx is a value sufficiently smaller than Ra (Ra>>Rx). If Vs4 is in the range of Xd≥Vs4≥0, the CPU 4 determines that the manual opening switch S4 has been operated, and outputs the window opening command signal for giving an instruction to manually open of the window W to the motor drive unit 3.

FIG. 5 illustrates a state of a change in the potentials V1 and V2 at the time of submersion. In the operation unit 1 (FIG. 1), the switches S1 to S4 have a waterproof structure in which water does not enter, but the terminal T1 is exposed to the outside, and the terminal T3 of the control unit 2 is also exposed to the outside (same applies to terminals T2 and T4). Therefore, when electric leakage occurs at the terminals T1 and T3 due to submersion, the current flowing through the switch circuits 1A and 1B decreases, so that the potential V1 becomes lower than that at the normal time in FIG. 4. Further, since the electrodes of the submersion detection sensor Q are short-circuited at the time of submersion, the potential V2 is also lower than that at the normal time in FIG. 4.

In FIG. 5, in a case where none of the switches S1 to S4 is operated, the potentials V1 and V2 are B1≥V1>Xd and Ya≥V2≥0, respectively. In this state, when the auto-opening switch S1 is operated and turned on, the potential V1 drops to Vs1′, and when the auto-closing switch S2 is operated and turned on, the potential V1 drops to Vs2′ and when the manual closing switch S3 is operated and turned on, the potential V1 drops to Vs3′. However, since no threshold value is set for these switches S1 to S3, the presence or absence of the operation is not determined (OFF state). That is, in the submerged state, the operations of the switches S1 to S3 are ignored. Therefore, at the time of submersion, even if the potential V1 is the potentials Vs2′ and Vs3′ when the auto-closing switch S2 and the manual closing switch S3 are operated, the window closing command signal is not output from the CPU 4 to the motor drive unit 3, and the window W does not close.

On the other hand, when the manual opening switch S4 is operated and turned on in the submerged state, the potential V1 drops to Vs4′. Since the threshold value Xd is set for the switch S4, if Xd≥Vs4′≥0, the CPU 4 determines that the manual opening switch S4 has been operated, and outputs the window opening command signal instructing the manual opening of the window W to the motor drive unit 3.

Therefore, at the time of submersion, the window W can be opened and escaped by operating the manual opening switch S4. Further, even if the auto-closing switch S2 or the manual closing switch S3 is operated at the time of submersion, those operations are ignored, so that it is possible to avoid a situation where the window W is closed and the occupant cannot escape.

When the submerged state is released, the electrodes of the submersion detection sensor Q are returned to the state of not short-circuited, so that the potential V2 increases and B2≥V2>Ya in FIG. 5. At this time, the CPU 4 determines that the state has changed from the submerged state to the non-submerged state, and switches the determination threshold value in FIG. 3 to the determination threshold value in FIG. 2. Therefore, the processing based on the above-mentioned normal determination threshold value is performed.

According to the above-described embodiment, the potential V1 at each one end of the switch circuits 1A and 1B, and the potential V2 at one end of the submersion detection sensor Q are separately monitored by the CPU 4. Then, in a case where the potential V2 is in the submersion potential range Z and the potential V1 indicates the operation of the manual opening switch S4, the window opening command signal is output from the CPU 4 to the motor drive unit 3.

Therefore, at the time of submersion when the potential V2 is in the submersion potential range Z, if the manual opening switch S4 is operated, the window W can be opened based on the window opening command signal output from the CPU 4 due to the change in the potential V1. On the other hand, even if the auto-closing switch S2 or the manual closing switch S3 is erroneously operated at the time of submersion, the window closing command signal is not output from the CPU 4, so that it is possible to avoid a situation where the window W is closed and safety is threatened. Therefore, without providing a switching element that turns on and off depending on the presence or absence of detection of the submersion detection sensor Q (JP-A-2018-100507, JP-B2-6634351, JP-A-2018-135726, and JP-A-2019-015115), a constant current circuit (JP-A-2020-087834), or the like, it is possible to open the window and realize the high safe power window device that can prevent the window from being erroneously closed when the window is opened at the time of submersion by a simple circuit configuration. In addition, it is possible to avoid a situation in which submersion detection cannot be performed due to a failure of the switching element, and reliability is improved.

In a power window device market, there is also a need for not requiring the submersion detection function as described above. In this case, in the power window device 100 of FIG. 1, the submersion detection circuit 10 and the terminal T2 are omitted in the operation unit 1, and the terminal T4 is omitted in the control unit 2. Therefore, the wiring L2 connecting the terminal T2 and the terminal T4 becomes unnecessary, and the harness can be reduced.

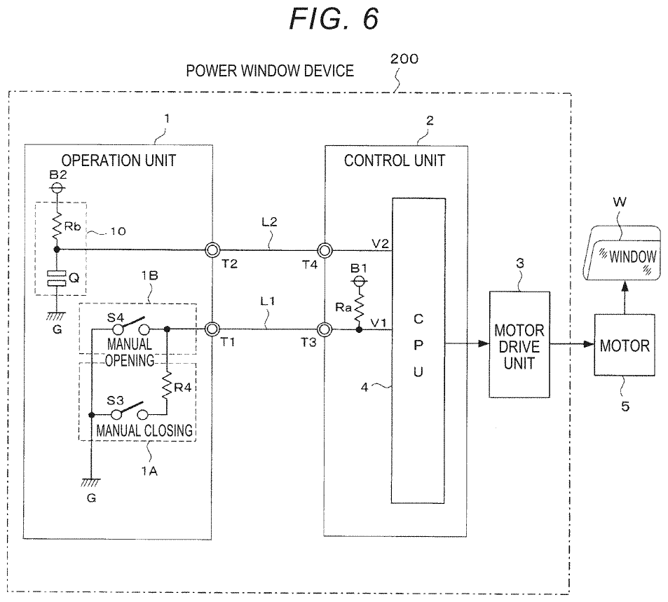

FIG. 6 illustrates a power window device 200 according to a second embodiment of the present invention. FIG. 6 is different from FIG. 1 in that the switch circuit 1A is configured of only a series circuit of the manual closing switch S3 and the voltage dividing resistor R4. The configuration of the switch circuit 1B is the same as that of FIG. 1, and the other configurations are also the same as those of FIG. 1.

That is, in the second embodiment, in the switch circuit 1A of FIG. 1, the auto-opening switch S1 and the auto-closing switch S2 are excluded, and the resistors R1 to R3 are replaced with the resistors R4. In the second embodiment, the threshold values Xb and Xc in FIG. 2 are omitted. Even with such a second embodiment, the same effect as that of the first embodiment can be obtained.

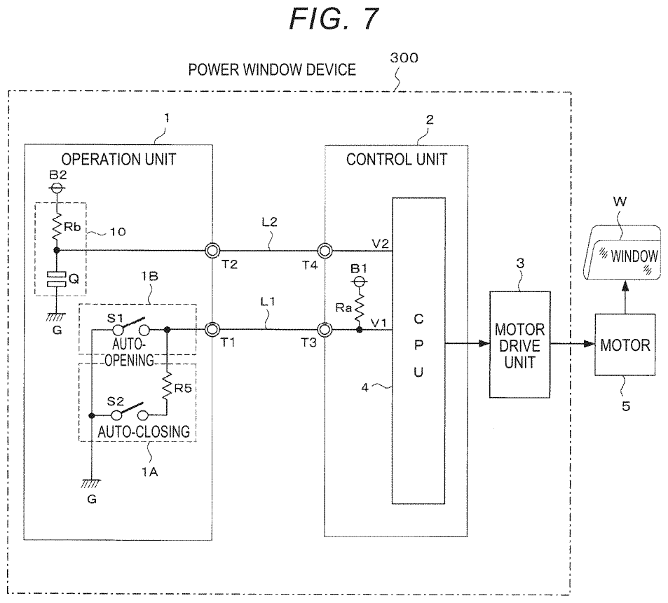

FIG. 7 illustrates a power window device 300 according to a third embodiment of the present invention. FIG. 7 is different from FIG. 1 in that the switch circuit 1A is configured of only a series circuit of the auto-closing switch S2 and the voltage dividing resistor R5, and the switch circuit 1B is configured of the auto-opening switch S1. Other configurations are the same as those in FIG. 1.

That is, in the third embodiment, in the switch circuit 1A of FIG. 1, the auto-opening switch S1, the manual closing switch S3, and the resistor R3 are excluded, the resistors R1 and R2 are replaced with the resistors R5, and in the switch circuit 1B of FIG. 1, the manual opening switch S4 is replaced with the auto-opening switch S1. In the third embodiment, the threshold values Xa and Xd in FIG. 2 are omitted, and the window W opens in a case where the auto-opening switch S1 is operated in the submerged state (Xc≥V1≥0). With such a third embodiment, the same effects as those of the first and second embodiments can be obtained.

In the present invention, various embodiments can be adopted in addition to the above-described embodiments.

For example, in the above-described embodiment, an example is given in which the submersion detection circuit 10 is provided in the operation unit 1, but the submersion detection circuit 10 may be provided in the control unit 2. Alternatively, the submersion detection circuit 10 may be provided separately from the operation unit 1 and the control unit

Further, in the above-described embodiment, an example is given in which the pull-up resistor Rb is provided in the operation unit 1, but the pull-up resistor Rb may be provided in the control unit 2.

Further, in the above-described embodiments, an example is given in which the motor drive unit 3 is provided separately from the control unit 2, but the motor drive unit 3 may be incorporated into the control unit 2.

Further, in the above-described embodiments, an example is given in which the motor 5 is provided outside the power window devices 100, 200, and 300, but the motor 5 may be provided in the power window devices 100, 200, and 300.

Further, in the above-described embodiments, an example is given in which the power window devices 100, 200, and 300 are provided for a vehicle, but the present invention can also be applied to power window devices used in fields other than the vehicle.

While the invention has been described with respect to a limited number of embodiments, those skilled in the art, having benefit of this disclosure, will appreciate that other embodiments can be devised which do not depart from the scope of the invention as disclosed herein. According, the scope of the invention should be limited only by the attached claims.

1. A power window device comprising:
an operation unit comprising a window closing switch that is operated to close a window and a window opening switch that is operated to open the window;
a motor drive unit that drives a motor to open and close the window;
a control unit that controls an operation of the motor drive unit based on an operation of each switch of the operation unit; and
a submersion detection circuit that detects submersion,
wherein the operation unit comprises:
a first switch circuit connected between a first power supply and a ground, the first switch circuit comprising a series circuit of the window closing switch and a resistor; and
a second switch circuit connected between the first power supply and the ground in parallel with the first switch circuit, the second switch circuit comprising the window opening switch,
wherein the submersion detection circuit comprises a submersion detection sensor connected between a second power supply and the ground,
wherein the control unit is configured to:
monitor independently a first potential at one ends of the first switch circuit and the second switch circuit on a first power supply side and a second potential at one end of the submersion detection sensor on a second power supply side; and
determine that submersion has occurred when the second potential is in a preset submersion potential range,
wherein during a normal time when there is no submersion, the control unit
outputs a window closing command signal for giving an instruction to close the window to the motor drive unit when the first potential is a potential at a time of the window closing switch being operated, and
outputs a window opening command signal for giving an instruction to open the window to the motor drive unit when the first potential is a potential at a time of the window opening switch being operated, and
wherein at a time of submersion in which submersion occurs, the control unit
does not output the window closing command signal to the motor drive unit even when the first potential is the potential at the time of the window closing switch being operated, and
outputs the window opening command signal to the motor drive unit when the first potential is the potential at the time of the window opening switch being operated,

2. The power window device according to claim 1,
wherein with respect to the first potential, a window dosing threshold value for determining presence or absence of an operation of the window closing switch and a window opening threshold value for determining presence or absence of an operation of the window opening switch are set in the control unit,
wherein with respect to the second potential, a submersion threshold value for determining presence or absence of submersion is set in the control unit and the submersion potential range is a range between the submersion threshold value and zero volt, and
wherein the window closing threshold value and the window opening threshold value are smaller than the submersion threshold value.

3. The power window device according to claim 2,
wherein when it is determined that submersion has occurred based on the submersion threshold value, the control unit does not determine presence or absence of the operation of the window closing switch based on the window closing threshold value and only determines presence or absence of the operation of the window opening switch based on the window opening threshold value.

4. The power window device according to claim 2,
wherein the window opening threshold value is smaller than the window closing threshold value.

5. The power window device according to claim 1,
wherein the window closing switch comprises a manual closing switch for manually closing the window and an auto-closing switch for automatically closing the window,
wherein the window opening switch comprises a manual opening switch for manually opening the window and an auto-opening switch for automatically opening the window,
wherein the resistor comprises a first voltage dividing resistor, a second voltage dividing resistor, and a third voltage dividing resistor,
wherein the first switch circuit comprises the auto-opening switch, the auto-closing switch, the manual closing switch, the first voltage dividing resistor, the second voltage dividing resistor, and the third voltage dividing resistor,
wherein the second switch circuit comprises the manual opening switch,
wherein in the first switch circuit, a series circuit of the manual closing switch, the first voltage dividing resistor, the second voltage dividing resistor, and the third voltage dividing resistor, a series circuit of the auto-closing switch, the first voltage dividing resistor, and the second voltage dividing resistor, and a series circuit of the auto-opening switch and the first voltage dividing resistor are connected between the first power supply and the ground, and
wherein in the second switch circuit, the manual opening switch is connected between the first power supply and the ground.

6. The power window device according to claim 1,
wherein the operation unit comprises a first terminal to which each of the one ends of the first switch circuit and the second switch circuit is connected and a second terminal to which the one end of the submersion detection sensor is connected,
wherein the control unit comprises a third terminal connected to the first terminal by a first wiring and a fourth terminal connected to the second terminal by a second wiring,
wherein the third terminal is connected to the first power supply via a first pull-up resistor, and the fourth terminal is connected to the second power supply via a second pull-up resistor, and
wherein the control unit monitors a potential at the third terminal as the first potential and monitors a potential at the fourth terminal as the second potential.
